(19) United States
(12) Patent Application Publication
(10) Pub. No.: US 2013/0095335 A1
(43) Pub. Date: Apr. 18, 2013

(54) Film Composition for Controlled Peelable Seal Film

(71) Applicant: Becton, Dickinson and Company, Franklin Lakes, NJ (US)

(72) Inventor: Theresa Hermel-Davidock, Newton, NJ (US)

(73) Assignee: Becton, Dickinson and Company, Frankllin Lakes, NJ (US)

(21) Appl. No.: 13/650,604

(22) Filed: Oct. 12, 2012

Related U.S. Application Data
(60) Provisional application No. 61/547,820, filed on Oct. 17, 2011.

(51) Int. Cl. B32B 27/32

(52) U.S. Cl. 428/516

(57) ABSTRACT

The present invention provides polymeric film and, more particularly, a multi-layer polymeric film including one or more structural layers of homogenous polypropylene; one or more structural layers of random copolymer polypropylene; one or more anhydride modified polyethylene based tie layers; one or more linear low density polyethylene (LLDPE) blend sealant layers having a primary LLDPE component, a secondary LLDPE component, and an optional LDPE additive component

### TECHNICAL FIELD

Aspects of the present invention relate to polymeric film and, more particularly, relate to a multi-layer polymeric film including one or more structural layers of homogenous polypropylene; one or more structural layer of random copolymer polypropylene; and a polypropylene-based sealant layer or sealant layer of one or more linear low density polyethylene (LLDPE) blend sealant layers having a primary LLDPE component, a secondary LLDPE component, and an optional LDPE additive component.

### BACKGROUND

Many of the polymeric films used in industry today still fail to be recyclable. Due to increased environmental awareness and a desire to decrease environmental impact, a need still exist for a recyclable polypropylene/polyethylene film having tailor-able physical and sealant properties, for example, good formability, toughness and impact strength at thin gauges. Moreover, despite advances in polyethylene peelable sealant technology, poor seal performance and a narrow seal processing window to direct seal paper can occur as a result of a failure to optimize sealant performance. For example, too strong of a peel strength results in fiber tear and too weak of peel strength may compromise a sterile product.

European Patent EP 1 736 309 A1 entitled “Packaging Obtained by Direct Contact Seal” discloses a direct contact seal comprising a coextruded multilayer film composed of a polyolefin based seal layer with a Tm<135° C., comprised up to 30% polybutene-1 for peel-seal applications and a second polypropylene based support layer with a Tm>135° C. However, the film of EP 1 736 309 requires the addition of polybutene-1 and/or a specific Tm and modulus difference between the seal layer and support layer.

European Patent EP 1 453 671 B1 entitled “Peelable Seal Film” discloses a heat sealable coextruded multilayer film peelable to a variety of substrates. The seal layer is comprised of 50-80 wt % ethylene homo &/or copolymer, 15-25 wt % styrene homo &/or copolymer, and 5-20 wt % thermoplastic elastomer SBS copolymer, with preference for the addition of 10-20 wt % homogeneously branched LLDPE to control peel-seal. However, European Patent EP 1 453 671 B requires the addition of SBS or styrene homo &/or copolymer.

International Patent Publication WO 03/04343816 A1 entitled “Peelable Seal Film” discloses a heat sealable coextruded multilayer film peelable to a variety of substrates. The seal layer is comprised of 50-80 wt % ethylene homo &/or copolymer, 15-25 wt % styrene homo &/or copolymer, and 5-20 wt % thermoplastic elastomer SBS copolymer, with preference for the addition of LLDPE and/or polybutylene-1 to control peel-seal. Similar to European Patent EP 1 453 671 B1, International Patent Publication WO 03/04343816 requires the addition of SBS or styrene homo &/or copolymer.

U.S. Pat. No. 5,681,523A entitled “Medium Modulus Polyethylene Film and Fabrication Method” discloses a film comprised of a high molecular weight linear PE (0.92-0.96 g/cc & 0.1 to 3 MI) and linear ethylene/alpha-olefin interpolymer (0.85 to 0.92 g/cc & 0.3 to 3 MI), with an overall density between 0.923 to 0.95 g/cc. Additional background examples given included: a) LLDPE w/ LDPE, b) HDPE w/ rubber or other elastomer, c) LLDPE w/ low MW HDPE, d) LLDPE w/ high MFR HDPE, and LLDPE w/ an isotactic polymer. It was noted in the body of the patent that increasing the gauge does not proportionately enhance the physical properties of the film. The overall density range of the films disclosed in US 005681523A prevent an effective low temperature heat seal and hot tack performance. US 005681523A fails to address seal performance of the film disclosed therein.

U.S. Patent Publication No. 2003/0143416A1 entitled “Layered Film and Packaging Product Thereof” and U.S. Pat. No. 6,794,029B2 entitled “Layered Film and Packaging Product Thereof” disclose layered film comprised of at least two layers of a resin: composition layer A) 60-90 mass % LLDPE produced using a single-site catalyst and 40-10% mass % of polybutene-1 and layer B) HDPE (0.950-0.970). U.S. Patent Publication No. 2003/0143416A1 and U.S. Pat. No. 6,794,029B2 require the addition of polybutene-1 to the seal layer.

International Patent Publication WO 2006/108266A1 entitled “Dual Reactor Polyethylene Resins for Medical Packaging—Films, Bags and Pouches” and U.S. Patent Publication No. 2006/0235146A1 entitled “Dual Reactor Polyethylene Resins for Medical Packaging—Films, Bags and Pouches” disclose tandem dual reactor solution phase polymerization in the presence of a phosphinimine catalyst and a co-catalyst system which comprises an aluminum based co-catalysts.

U.S. Pat. No. 6,632,521B2 entitled “Polymeric Films and Packages Produced Therefrom” and EP 1167437A1 entitled “Polymeric Films and Packages Produced Therefrom” disclose polymeric films having a least one outer layer consisting of a blend of LDPE (0.915-0.930 g/cc and MFI 2.0-40.0 g/10 min) and a poly(alkylstyrene).

U.S. Patent Publication No. 2002/0160135A1 entitled “Polymeric Films and Packages Produced Therefrom” and International Patent Publication WO 01/66639A1 entitled “Polymeric Films and Packages Produced Therefrom” disclose heat sealable films comprised of a seal layer blended of at least one polyethylene and a cyclic olefin/ethylene copolymer having a Tg>30° C.

Therefore, due to increased environmental awareness and a desire to decrease environmental impact, a need exists in the industry to create a recyclable universal polypropylene/polyethylene film with tailor-able physical and sealant properties. It is desirable to produce polypropylene films having the comparable sealing performance to that of traditional polyethylene based sealant structures; with improved properties, such as enhanced optical properties(high clarity/low haze), improved formability, and improved mechanical properties, including high toughness and impact strength.

### SUMMARY OF THE INVENTION

One or more embodiments of the present invention create a recyclable universal bottom web polypropylene/polyethylene film with tailor-able physical and sealant properties.

In one embodiment of the present invention, a multi-layer polymeric film is provided that comprises one or more structural layers of homogenous polypropylene and having a melt flow rate from 0.5 to 10 MFR; one or more structural layers of random copolymer polypropylene having a melt flow rate from 0.5 to 10 MFR; one or more polypropylene-based sealant layers having a melt flow rate from 0.5 to 10 MFR; wherein the multi-layer polymeric film has an elongation at break measured in accordance with ASTM D 882 of greater than 400%; a delamination strength of greater than 1500 gf/in; Spencer impact strength measured in accordance with ASTM D 3420 of more than 800 mJ; a puncture strength of greater than 7 lbs; a seal initiation temperature less than or equal to 120° C.; a seal strength measured in accordance with ASTM F88-07a in the range of 100 gf/in to 2000 gf/in.

The one or more structural layers of homogenous polypropylene may be from 20 to 60 weight percent of the film, based on the total weight of the film. The one or more structural layers of random copolymer polypropylene may from 30 to 70 weight percent of the film, based on the total weight of the film. The high ethylene content random copolymer polypropylene may have greater than or equal to 3% ethylene weight percentage. The sealant layer may be from 10 to 40 weight percent of the film, based on the total weight of the film, and may have a density in the range from 0.850 to 0.905 g/cm³. In one or more embodiment, the sealant layer may be a polypropylene based plastomer or polypropylene based elastomer. The multi-layer polymeric film is entirely recyclable.

In another embodiment of the present invention, a multi-layer polymeric film is provided having one or more linear low density polyethylene (LLDPE) blend sealant layer having a primary Metallocene LLDPE component, and an optional LDPE additive component; one or more structural layers of random copolymer polypropylene having a melt flow rate from 0.5 to 10 MFR; one or more structural layer of homogenous polypropylene and having a melt flow rate from 0.5 to 10 MFR; one or more linear low density polyethylene (LLDPE) blend sealant layers having a primary Ziegler-Natta LLDPE component, and an optional LDPE additive; wherein the multi-layer polymeric film has an elongation at break measured in accordance with ASTM D 882 of greater than 400%; a delamination strength of greater than 1500 gf/in; Spencer impact strength measured in accordance with ASTM D 3420 of more than 800 mJ; a puncture strength of greater than 7 lbs; a seal initiation temperature less than or equal to 120° C.; a seal strength measured in accordance with ASTM F88-07a in the range of 100 gf/in to 2000 gf/in; and a seal window greater than 30° C.

In one or more embodiments, the LLDPE sealant layer may comprise an LDPE additive component.

In one or more embodiments, the LLDPE sealant layer may have a primary Metallocene LLDPE component is from 10 to 30 weight percent of the film and up to 40% secondary LDPE component, based on the total weight of the film.

In one or more embodiments, the structural layers of random copolymer polypropylene may be from 10 to 30 weight percent of the film, based on the total weight of the film. In one or more embodiments, the structural layers of homogenous polypropylene is from 5 to 30 weight percent of the film, based on the total weight of the film. In one or more embodiments, the linear low density polyethylene (LLDPE) blend sealant layer having a primary Ziegler-Natta LLDPE component is from 10 to 35 weight percent of the film and up to 50% secondary LDPE component, based on the total weight of the film.

The multi-layer polymeric film is entirely recyclable and thermoformable.

In yet another embodiment of the present invention, a multi-layer polymeric film is provided having one or more structural layers of random copolymer polypropylene having a melt flow rate from 0.5 to 10 MFR; one or more structural layers of homogenous polypropylene and having a melt flow rate from 0.5 to 10 MFR; one or more polypropylene-based plastomer/elastomer sealant layer having a melt flow rate from 0.5 to 10 MFR with an optional LDPE additive component; wherein the multi-layer polymeric film has an elongation at break measured in accordance with ASTM D 882 of greater than 400%; a delamination strength of greater than 1500 gf/in; Spencer impact strength measured in accordance with ASTM D 3420 of more than 800 mJ; a puncture strength of greater than 7 lbs; a seal initiation temperature less than or equal to 120° C.; a seal strength measured in accordance with ASTM F88-07a in the range of 100 gf/in to 2000 gf/in.

In a specific embodiment, the polypropylene-based plastomer/elastomer sealant layer is from 10 to 30 weight percent of the film and up to 50% secondary LDPE component, based on the total weight of the film. A second structural layer of random copolymer polypropylene is from 10 to 30 weight percent of the film, based on the total weight of the film. A third structural layer of homogenous polypropylene is from 5 to 30 weight percent of the film, based on the total weight of the film. A fourth structural layer is from 10 to 30 weight percent of the film, based on the total weight of the film. A fifth polypropylene-based plastomer/elastomer sealant layer is from 10 to 35 weight percent of the film and up to 50% secondary LDPE component, based on the total weight of the film.

The multi-layer polymeric film is entirely recyclable and thermoformable.

In yet another embodiment of the present invention, a multi-layer polymeric film is provided having one or more polypropylene-based plastomer/elastomer sealant layers having a melt flow rate from 0.5 to 10 MFR with an optional LDPE additive component; one or more structural layers of homogenous polypropylene having a melt flow rate from 0.5 to 10 MFR; one or more structural layers of random copolymer polypropylene having a melt flow rate from 0.5 to 10 MFR; wherein the multi-layer polymeric film has an elongation at break measured in accordance with ASTM D 882 of greater than 400%; a delamination strength of greater than 1500 gf/in; Spencer impact strength measured in accordance with ASTM D 3420 of more than 800 mJ; a puncture strength of greater than 7 lbs; a seal initiation temperature less than or equal to 120° C.; a seal strength measured in accordance with ASTM F88-07a in the range of 100 gf/in to 2000 gf/in.

In one or more embodiments, the first polypropylene-based plastomer/elastomer sealant layer may be from 10 to 30 weight percent of the film and up to 50% secondary LDPE component, based on the total weight of the film. In one or more embodiments, the second structural layer of homogenous polypropylene may be from 5 to 15 weight percent of the film, based on the total weight of the film. In one or more embodiments, the third structural layer of random copolymer polypropylene may be from 30 to 50 weight percent of the film, based on the total weight of the film. In one or more embodiments, the fourth structural layer of homogenous polypropylene is from 5 to 15 weight percent of the film, based on the total weight of the film. In one or more embodiments, the fifth polypropylene-based plastomer/elastomer sealant layer may be from 10 to 35 weight percent of the film and up to 50% secondary LDPE component, based on the total weight of the film.

The multi-layer polymeric film is entirely recyclable and thermoformable.

Yet another aspect of the present invention pertains to various applications of the polymeric film described herein including but not limited to, use in blister packaging, vertical or horizontal form fill seal packaging, flow wrap and pouch film.

### BRIEF DESCRIPTION OF THE DRAWINGS

FIG. 1 shows an embodiment of the multi-layer polymeric film of the present invention having a first structural layer of homogenous polypropylene; a second structural layer of random copolymer polypropylene; and a polypropylene based sealant layer;

FIG. 2 shows an embodiment of the multi-layer polymeric film of the present invention having a linear low density polyethylene (LLDPE) blend sealant layer having a primary Metallocene LLDPE component; a second structural layer of random copolymer polypropylene; a third structural layer of homogenous polypropylene; a fourth structural layer of random copolymer polypropylene; and a linear low density polyethylene (LLDPE) blend sealant layer having a primary Ziegler-Natta LLDPE component;

FIG. 3 shows an embodiment of the multi-layer polymeric film of the present invention having a polypropylene-based plastomer/elastomer sealant top layer; a second structural layer of random copolymer polypropylene; a third structural layer of homogenous polypropylene; a fourth structural layer of random copolymer polypropylene; and a polypropylene-based plastomer/elastomer sealant layer; and

FIG. 4 shows an embodiment of the multi-layer polymeric film of the present invention having a polypropylene-based plastomer/elastomer sealant top layer; a second structural layer of homogenous polypropylene; a third structural layer of random copolymer polypropylene; a fourth structural layer of homogenous polypropylene; and a polypropylene-based plastomer/elastomer sealant layer.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

The present invention relates to a multi-layer polymeric film comprised of only olefin based polymers offering performance and low cost. With the use of polypropylene (PP) and polyethylene (PE) based layers, the multi-layer polymeric film of the present invention provides for a recyclable and sustainable film. One or more embodiments of the present invention relates to various applications for the polymeric film described herein including, but not limited to, vertical or horizontal form fill seal packaging, flow wrap; pouches and bags; and top and bottom web polymeric film for flexible blister packaging, such as in primary packaging for medical devices. One or more embodiments of the present invention provide a universal polymer film with tailor-able physical and sealant properties through modification of the gauge, % support layer, and sealant layer composition, including resin selection and blend ratio. A PE based sealant layer composition can be comprised of a linear low density polyethylene (LLDPE) resin or potential blend of LLDPE resins, including ethylene based elasotomers or plastomers. The sealant performance of the film can be tailored by the addition of a second LLDPE component or components, and based on the PE resin selections, including molecular weight (MW), MW distribution, comonomer (or short chain branching) type, comonomer content, comonomer distribution, and long chain branching content. The sealant performance of the film can be further tailored by blending with an HDPE, MDPE, LDPE, or other alpha olefin copolymers. A PP based sealant layer composition can be comprised of a blend of PP plastomers or elastomers. The sealant performance of the film can be tailored by the addition of a second PP and/or PE component, and based on the PP resin selections, including MFR, comonomer type, and comonomer content. The sealant performance of the film can be further tailored by blending with an high density polyethylene (HDPE), medium density polyethylene (MDPE), low density polyethylene (LDPE), or other alpha olefin copolymers, including ethylene based elasotomers or plastomers. As well as PP-based resins such random-PP and other PP elastomers or plastomers.

Embodiments of the present invention provide seal performance to sealant coated paper, polymeric nonwovens such as Tyvek and those coated with a sealant layer, top web polymer based films and uncoated, or direct seal, paper comparable to packaging resins such as ionomers (Surlyn) and copolymers like ethylene vinyl acetate (EVA), while allowing for a broad processing window, optimization of peel strength, cost-savings and recyclability.

The components of the polymeric film 10 of the present invention are discussed in more detail below.

### Homopolypropylene Resin Structural Layer

The multi-layer polymeric film may be comprised of one or more structural layers of homopolypropylene resin 20 wherein each structural layers of homopolypropylene resin 20 may be from 5 to 60 weight percent of the film, based on the total weight of the film. In a specific embodiment of the present invention, each structural layer of homopolypropylene resin 20 is from 5 to 30 weight percent of the film, preferably 15 to 20 weight percent of the film, based on the total weight of the film. In another specific embodiment of the present invention, each structural layer of homopolypropylene resin 20 is from 5 to 15 weight percent of the film, preferably 10 weight percent of the film, based on the total weight of the film. In yet another specific embodiment of the present invention, each structural layer of homopolypropylene resin 20 is about 20 to 60 weight percent of the film, preferably 20 to 40 weight percent of the film, based on the total weight of the film. The structural layer of homopolypropylene resin 20 is characterized by having a melt flow rate from 0.5 to 10 MFR can be utilized, targeted to the physical properties desired. Metallocene-based isotactic PP can be utilized for enhanced optical and mechanical properties and lower CoF if a surface layer.

### Random Ethylene Copolymer Polypropylene Structural Layer

The multi-layer polymeric film may be comprised of one or more structural layers of a random ethylene copolymer PP 30 wherein each structural layers of random ethylene copolymer PP may be from 10 to 70 weight percent of the film, based on the total weight of the film. In a specific embodiment of the present invention, each structural layer of random ethylene copolymer polypropylene resin 30 is from 10-30 weight percent of the film, preferably 20 to 25 weight percent of the film, based on the total weight of the film. In another specific embodiment of the present invention, each structural layer of random ethylene copolymer polypropylene resin 30 is from 30 to 50 weight percent of the film, preferably 35 to 45 weight percent of the film, based on the total weight of the film. In another specific embodiment of the present invention, each structural layer of random ethylene copolymer polypropylene resin 30 is from 30 to 70 weight percent of the film, preferably 30 to 50 weight percent of the film, based on the total weight of the film. The structural layer of random ethylene copolymer polypropylene resin 30 is characterized by having an alpha olefin comonomer of 1-5%, with a comonomer of ethylene. A melt flow rate from 0.5 to 10 MFR can be utilized. In a specific embodiment of the present invention, the melt flow rate is in the range of 1-2 MFR and the ethylene comonomer content is equal to or greater than 3%.

### Linear Low Density Polyethylene (LLDPE) Sealant Layer

The multi-layer polymeric film may be comprised of one or more linear low density polyethylene (LLDPE) sealant layers 40 wherein each LLDPE sealant layer 40 is from 10 to 35 weight percent of the film, preferably 15 to 20 weight percent of the film, based on the total weight of the film. The one or more LLDPE sealant layer 40 is characterized by having an overall density in the range from 0.880 to 0.930 g/cm³. The one or more LLDPE sealant layer 40 is further characterized by having a melt index from 0.7 to 3.5 MI. In a specific embodiment of the present invention, the one or more LLDPE sealant layers 40 have a melt index from 0.8 to 2 MI.

The primary LLDPE component of the one or more sealant layers comprises a low long chain branching and heterogeneous molecular weight and short chain branching (comonomer) distribution. The primary LLDPE component of the blend sealant layer is a Ziegler-Natta catalysized resin in an amount from 50 to 100 weight percent of the sealant layer blend, based on the total weight of the sealant layer blend. In one or more embodiments of the present invention, the Ziegler-Natta catalysized resin is in an amount from 70 to 80 weight percent of the sealant layer blend, based on the total weight of the sealant layer blend. The primary LLDPE component of the blend sealant layer is characterized by having a density in the range from 0.850 to 0.930 g/cm³. In one or more embodiments, the primary LLDPE component of the blend sealant layer has a melt index from 0.7 to 3.5 MI. In one or more embodiments, the primary LLDPE component of the blend sealant layer is further characterized by having a melt index from 1 to 2 MI. The primary LLDPE component of the sealant layer can also include a heterogeneous branched, linear ethylene interpolymer, elastomer or plastomer.

The optional secondary LLDPE component comprises a low long chain branching and a homogeneous molecular weight and short chain branching comonomer distribution. The secondary LLDPE component of the blend sealant layer is a Metallocene or post-Metallocene catalysized resin in an amount from 0 to 40 weight percent of the sealant layer blend, based on the total weight of the sealant layer blend. In one or more embodiments, the Metallocene or post-Metallocene catalysized resin is in an amount from 0 to 10 weight percent of the sealant layer blend, based on the total weight of the sealant layer blend. In one or more embodiments of the present invention, the secondary LLDPE component of the blend sealant layer has a melt index from 0.7 to 3.5 MI. In a specific embodiment of the present invention, the secondary LLDPE component of the blend sealant layer has a melt index from 1 to 2 MI.

The optional secondary LLDPE component of the blend sealant layer is characterized by having a density in the range from 0.850 to 0.930 g/cm³. The secondary LLDPE component of the sealant layer can also include a homogeneous branched, linear ethylene interpolymer, elastomer or plastomer.

### Polypropylene-Based Sealant Layer

The multi-layer polymeric film may be comprised of one or more polypropylene-based sealant layers 50 wherein the sealant layer is comprised of a high ethylene content random copolymer polypropylene. The high ethylene content random copolymer polypropylene has greater than or equal to 3% ethylene weight percentage. The sealant layer has a density in the range from 0.890 to 0.905 g/cm³. In one or more embodiments, the sealant layer 50 is a polypropylene based plastomer or polypropylene based elastomer; thermoplastic elastomer (TPE); high alpha-olefin content polypropylene copolymer; or C2-C3 random copolymer. In one embodiment, the sealant layer 50 is blended with one or more of the following homoPP, or a PE such as LDPE, LLDPE, MDPE, HDPE at 0-50%. In yet another embodiment, the sealant layer is blended with one or more of the following, homoPP, or a PE such as LDPE, LLDPE, MDPE, HDPE at 0-20%. In one or more embodiments, the sealant layer has a density in the range from 0.850 to 0.905 g/cm³. The polypropylene-based sealant layer 70 is from 10 to 40 weight percent of the film, based on the total weight of the film. In a specific embodiment of the present invention, the sealant layer is from 20 to 30 weight percent of the film, based on the total weight of the film. In a specific embodiment of the present invention, each polypropylene-based sealant layer 40 is from 10 to 35 weight percent of the film, preferably from 15 to 20 weight percent of the film, based on the total weight of the film. In a specific embodiment of the present invention, each polypropylene-based sealant layer 40 is from 10 to 30 weight percent of the film, preferably from 15 to 20 weight percent of the film, based on the total weight of the film.

An optional heterogeneous Z.N. catalyzed LLDPE component may be added to polypropylene-based sealant layer in an amount of 0-50% weight percent Z.N. catalyzed LLDPE, preferably 20-40% weight percent Z.N. catalyzed LLDPE, to broaden out the heat seal window and lower the ultimate seal strength. The preferred overall melt index (MI) of the heterogeneous Z.N. catalyzed LLDPE component is 1-3 MI and overall density 0.910 to 0.918 g/cc.

### Additive of the Blend Sealant Layer

The additive of the blend sealant layer is a low density polyethylene (LDPE) in an amount from 0 to 50 weight percent of the sealant layer blend, based on the total weight of the sealant layer blend. In a specific embodiment of the present invention, the additive is in an amount from 0 to 20 weight percent of the sealant layer blend, based on the total weight of the sealant layer blend when the LLDPE component of the blend sealant layer is a Metallocene or post-Metallocene catalysized resin. In a specific embodiment of the present invention, the additive is in an amount from 20 to 30 weight percent of the sealant layer blend, based on the total weight of the sealant layer blend when the LLDPE component of the blend sealant layer is a Ziegler-Natta catalysized resin. The LDPE additive component of the blend sealant layer is characterized by having a density in the range from 0.910 to 0.935 g/cm³. The additive component of the blend sealant layer is characterized by having a melt index in the range from 0.7 to 3.5 MI. In a specific embodiment of the present invention, the additive component of the blend sealant layer has a melt index from 1 to 2 MI. A medium density PE (MDPE) or high density PE (HDPE), homogeneous branched LLDPE, elastomer or plastomer could so be used.

Additives include, but are not limited, anti-static agents, anti-oxidant agents (such as hindered phenolics (e.g. Tetrakis(methylene-3-(3,5-di-tert-butyl-4-hydroxyphenyl)propionate)methane) like Irganox™ 1010 from BASF or Songnox 1010™ from Songwon) or (e.g. octadecyl-3-(3,5-di-tert-butyl-4-hydroxyphenyl)propionate like Irganox™ 1076 from BASF), UV stabilizers (e.g. N,N-distearylhydroxylamine like Irgastab FS 042 from BASF or Hindered Amine Light Stabilizer (HALS) such as Bis(1,2,2,6,6-pentamethyl-4-piperidinyl) sebacate like BLS 929 from Mayzo, Inc. and triphenylphospate from Bayer), radiation stabilizers, slip agents, anti-block agents, processing agents, lubricants, clarifying agents, nucleating agents, anti-yellowing agents, colorants, fillers, stiffening or toughening agents, pigments, blowing agents, plasticizers such as di-isononyl phthalate (DINP), crosslinking agents, and cling additives. In an embodiment, the surface layers of the film contain 0-5000 ppm slip agent, 0-120000 ppm antiblock, and, for the polypropylene-based sealant layer, 0-3000 ppm processing aid. The additives are incorporated as a masterbatch using an LLDPE carrier resin. A PP-based carrier resin may be used for addition to a PP based resin. In a preferred embodiment the surface layers of the film contains 500-2000 ppm slip agent, 1000-4000 ppm antiblock, and, for the polypropylene-based sealant layer, 200-1000 ppm processing aid.

Additional examples of additives that could be utilized in any, or all, layer of the film structure include, but are not limited to, Tris(3,5-di-tert-butyl-4-hydroxybenzyl)iso-cyanurate; 1,3,5-Trimethyl-2,4,6-tris(3,5-di-tert-butyl-4-hydroxybenzyl)benzene; Tri(butylcresyl)butane; N,N′-Hexamethylenebis(3,5-di-tert-butyl-4-hydroxyhydrocinnamamide); 4-ethyl-2,6-di-tert-butylphenol; N,N-distearylhydroxylamine; Tris(2,4-di-tert-butylphenyl)phosphite; Bis(2,4-di-tert-butylphenyl)pentaerythritol diphosphite; Distearyl pentaerythritol diphosphite; triphenylphosphate; Poy[6-[1,1,3,3-tetramethyl butyl)amino]-s-triazine-2,4-dinyl][2,2,6,6-tetramethyl-4-piperidyl)imino]hexamethylene[2,2,6,6-tetramethyl-4-piperidyl]iminol]; polymer of dimethyl succinate and 4-hydroxy-2,2,6,6-tetramethyl-1-piperidine ethanol; Bis(2,2,6,6-tetramethyl-4-piperidinyl)sebacate; hexadecyl-3,5-di-tert-butyl-4-hydroxybenzoate; 2-hydroxy-4-n-octoxybenzophenone; 2-(2′-hydroxy-5′-methylphenyl)benzotriazole; and 2-[2′-hydroxy-3′,5′-di(1,1-dimethylbenzyl)phenyl]-2H-benzotriazole.

The physical and processing properties of the film of the present invention can be tailored by changing the fraction of the structural layer(s) in the overall composition or by altering the ratio of the homo and random polypropylene layers, PP resin selection including the reactor, catalyst and visbreaking technology, melt flow rate (MFR) and/or ethylene comonomer content, and use of additives such as nucleating agents or by changing the overall gauge of the film. The sealant performance of the film can be tailored based on the PE resin selections, including MW, MW distribution, comonomer type, comonomer (or short chain branching) content, comonomer distribution, and long chain branching content. The sealant performance of the film can be further tailored by blending with an HDPE, LDPE, or other alpha olefin copolymers, homogeneous distribution LLDPE, elastomer or plastomer. The LLDPE component has a low long chain branching and heterogeneous molecular weight distribution (MWD) & SCBD, which can be achieved by a Ziegler-Natta catalyst. The amount of the heterogeneous LLDPE, and molecular properties of the resin selects, in the sealant layer will govern the seal performance, including: heat seal & hot tack initiation temperature, breadth of hot tack & heat seal window, and ultimate hot tack & heat seal strength. A secondary LDPE component or a LLDPE component can be added which has a low long chain branching and a homogeneous molecular weight and short chain branching (comonomer) distribution, MWD & SCBD, respectively. This can be achieved by a Metallocene, preferred post-Metallocene, catalyst. The sealant performance of the film can be tailored by blending ratio of the two LLDPE components. The sealant performance of the film can be further tailored by blending with an HDPE, LDPE, other alpha olefin copolymers such as elastomers or plastomers, or an additional heterogeneous catalysized LLDPE. In a specific embodiment, the preferred overall melt index (MI) is 1-3 MI and overall density 0.910 to 0.918 g/cc.

The LDPE component further broadens the seal window and lowers the seal strength to yield a peelable seal as well as enhance the melt strength of the resin enabling improved processability, especially in regards to bubble stability during the blown film process. The homogenous LLDPE component provides higher ultimate hot tack and seal strength due to its low level of long chain branching and narrow MW and SCB distributions. The broad MW and SCB distribution of the heterogeneous LLDPE component provides a measurable heat seal and hot tack strength at lower temperatures and broadens out the hot tack and heat seal window. The low MW, high comonomer content fraction associated with Ziegler-Natta catalysis LLDPE resins would lower the hot tack & heat seal strength & initiation temperature, therefore by adjusting the wt % of the LDPE or mLLDPE components one can tailor the seal strength of the film to ensure a proper peelable seal without fiber tear or other undesirable packaging failure modes. Higher levels of the homogenous LLDPE component could be utilized to create a welded seal, if desired.

Homogenous LLDPE component may be used as a surface layer to provide toughness, clarity, and an optional welded seal side. The additional of LDPE will increase melt strength and bubble stability, and lower the seal strength and broaden the seal window. Buried PP will offer decreased haze and increased stability to environmental exposure of the film over the lifetime of the packaged product. A plastomer and elastomer, such as Versify™ by Dow®, may be used to increase tear resistance.

Subsequently, the physical and formability properties of the film could be tailored by the selection of the polypropylene, or blends thereof. The homopolypropylene would offer high barrier properties, while offering high stiffness and toughness, as well as high clarity if a nucleating agent or clarifying agent is utilized, and chemical and temperature resistance. Polypropylene is inexpensive, easy to process and recyclable. The addition of a random copolymer polypropylene provides enhanced toughness, impact resistance, flexibility and improved optics. The addition of an impact copolymer polypropylene provides optimal impact/stiffness balance. To preserve recyclability, the films of the present invention do not contain any siloxane, vinyl acetate, styrene, alkylstyrene, vinyl alcohol, chlorides, phthalates, acrylates, acrylic acids, glycolic acids, methacrylic acids, vinyl acetates, urethanes, acrylics, or anhydrides.

The homo-polypropylene, random-PP, LDPE and Z.N and m-LLDPE resins for use in the polymeric film structure of the present invention are all commodity grade olefinic resins, offering a cost advantage over higher performance packaging resins such as anhydride modified LLDPE, ionomers (Surlyn) and copolymers like ethyl vinyl acetate (EVA). Down gauging and using commodity resins offers a further green advantage and would offer a lower cost.

The LLDPE resins proposed for the sealant layer a commodity grade PE resins, offering a cost advantage over the current best-in-class EVA or ionomer resins while providing comparable sealant performance. The broad hot tack and heat seal window offered by the LLDPE blend sealant layer of the present invention results in a more robust production window. Additionally, a film comprising a polypropylene/polyethylene structural layer, and polypropylene/polyethylene sealant layer provides for recyclability.

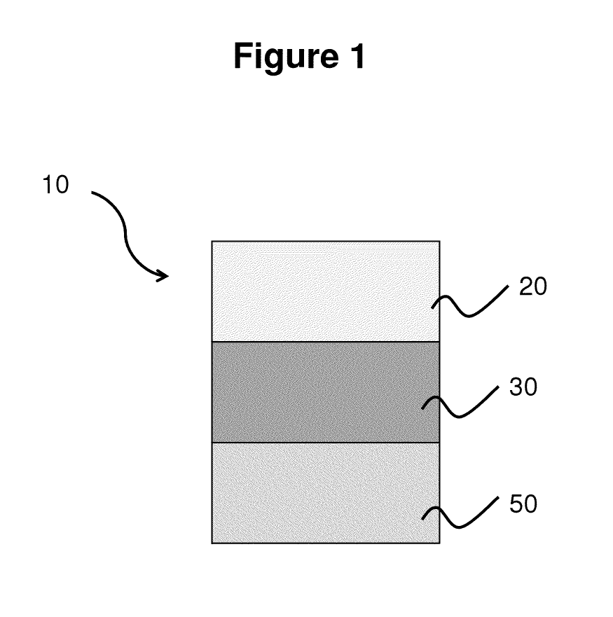

FIG. 1 shows an embodiment of the multi-layer polymeric film 10 of the present invention having a first structural layer of homogenous polypropylene 20; a second structural layer of high ethylene random copolymer polypropylene 30; and a polypropylene based plastomer/elastomer sealant layer 50.

The first structural layer component is a homo PP resin. The first structural layer of homogenous polypropylene 20 is from 20 to 60 weight percent of the film, preferably 20 to 40 weight percent of the film, based on the total weight of the film.

The second structural layer of high ethylene random copolymer polypropylene 30 is from 30 to 70 weight percent of the film, preferably from 30 to 50 weight percent of the film, based on the total weight of the film. The second structural layer of high ethylene random copolymer polypropylene 30 has a high ethylene content greater than or equal to 3% ethylene weight percentage.

The polypropylene based plastomer/elastomer sealant layer 50 is from 10 to 40 weight percent of the film, preferably from 20 to 30 weight percent of the film, based on the total weight of the film. The sealant layer 50 has a density in the range from 0.850 to 0.905 g/cm³.

The film is entirely recyclable.

The multi-layer polymeric film, as shown in FIG. 1, has an elongation at break measured in accordance with ASTM D 882 of greater than 400%, Spencer impact of more than 800 mJ; a puncture strength of greater than 7 lbs; a seal initiation temperature less than or equal to 120° C.; a seal strength measured in accordance with ASTM F88-07a in the range of 100 gf/in to 2000 gf/in; and a delamination strength of greater than 1500 gf/in wherein the elongation at break is measured in accordance with ASTM D 882; puncture is measured in accordance with ASTM D7192; Spencer impact is measured in accordance with ASTM D 3420; and ultimate seal strength is measured in accordance with ASTM F88-07a.

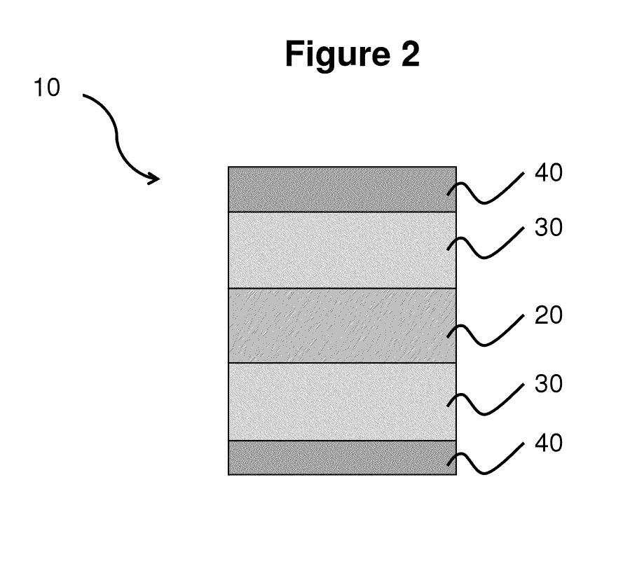

FIG. 2 shows an embodiment of the multi-layer polymeric film 10 of the present invention having a linear low density polyethylene (LLDPE) blend sealant layer 40 having a primary Metallocene LLDPE component, and an optional LDPE additive component; a second structural layer of random copolymer polypropylene 30; a third structural layer of homogenous polypropylene 20; a fourth structural layer of random copolymer polypropylene 30; and a linear low density polyethylene (LLDPE) blend sealant layer 40 having a primary Ziegler-Natta LLDPE component, and may have an optional LDPE additive component.

The linear low density polyethylene (LLDPE) blend sealant layer 40 has a primary Metallocene LLDPE component comprising from 10 to 30 weight percent of the film and up to 40% secondary LDPE component, based on the total weight of the film. In a preferred embodiment, the linear low density polyethylene (LLDPE) blend sealant layer 40 has a primary Metallocene LLDPE component comprising from 15 to 20 weight percent of the film and from 0 to 20% secondary LDPE component, based on the total weight of the film.

The second structural layer is an ethylene copolymer random PP 30 from 10 to 30 weight percent of the film, based on the total weight of the film. In a preferred embodiment, the second structural layer of ethylene copolymer random PP 30 is from 20 to 25 weight percent of the film, based on the total weight of the film.

The third structural layer of homogenous polypropylene 20 is from 5 to 30 weight percent of the film, based on the total weight of the film. In a preferred embodiment, the third structural layer of homogenous polypropylene 20 is from 15 to 20 weight percent of the film, based on the total weight of the film.

The fourth structural layer of an ethylene copolymer random PP 30 is from 10 to 30 weight percent of the film, based on the total weight of the film. In a preferred embodiment, the fourth structural layer of an ethylene copolymer random PP 30 is from 20 to 25 weight percent of the film, based on the total weight of the film.

The linear low density polyethylene (LLDPE) blend sealant layer 40 has a primary Ziegler-Natta LLDPE component from 10 to 35 weight percent of the film and up to 50% secondary LDPE component, based on the total weight of the film. In a preferred embodiment, the linear low density polyethylene (LLDPE) blend sealant layer 40 has a primary Ziegler-Natta LLDPE component from 15 to 20 weight percent of the film and from 20 to 30% secondary LDPE component, based on the total weight of the film.

The multi-layer polymeric film, as shown in FIG. 2, has an elongation at break measured in accordance with ASTM D 882 of greater than 400%, Spencer impact of more than 800 mJ; a puncture strength of greater than 7 lbs; a seal initiation temperature less than or equal to 120° C.; a seal strength measured in accordance with ASTM F88-07a in the range of 100 gf/in to 2000 gf/in; and a seal window greater than 30° C. and a delamination strength of greater than 1500 gf/in wherein the elongation at break is measured in accordance with ASTM D 882; puncture is measured in accordance with ASTM D7192; Spencer impact is measured in accordance with ASTM D 3420; and ultimate seal strength is measured in accordance with ASTM F88-07a.

The film is thermoformable and entirely recyclable

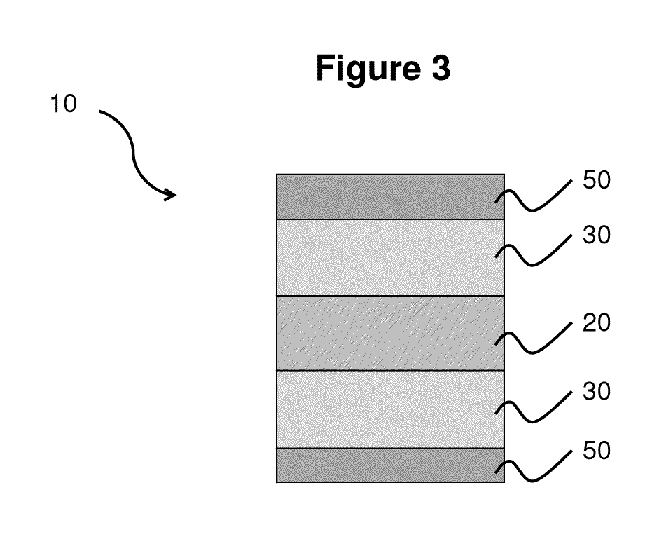

FIG. 3 shows an embodiment of the multi-layer polymeric film 10 of the present invention having a polypropylene-based sealant top layer 50; a second structural layer of random copolymer polypropylene 30; a third structural layer of homogenous polypropylene 20; a fourth structural layer of random copolymer polypropylene 30; and a polypropylene-based sealant layer 50.

The first polypropylene-based plastomer/elastomer sealant layer 50 is from 10 to 30 weight percent of the film and up to 50% secondary LDPE component, based on the total weight of the film. In a preferred embodiment, the first polypropylene-based plastomer/elastomer sealant layer 50 is from 15 to 20 weight percent of the film and from 0 to 20% secondary LDPE component, based on the total weight of the film.

The second structural layer of random copolymer polypropylene 30 is from 10 to 30 weight percent of the film, based on the total weight of the film. In a preferred embodiment, the second structural layer of random copolymer polypropylene 30 is from 20 to 25 weight percent of the film, based on the total weight of the film.

The third structural layer of homogenous polypropylene 20 is from 5 to 30 weight percent of the film, based on the total weight of the film. In a preferred embodiment, the third structural layer of homogenous polypropylene 20 is from 15 to 20 weight percent of the film, based on the total weight of the film.

The fourth structural layer of random copolymer polypropylene 30 is from 10 to 30 weight percent of the film, based on the total weight of the film. In a preferred embodiment, the fourth structural layer of random copolymer polypropylene 30 is from 20 to 25 weight percent of the film, based on the total weight of the film.

The fifth layer is a polypropylene-based plastomer/elastomer sealant layer 50 that is from 10 to 35 weight percent of the film and up to 50% secondary LDPE component, based on the total weight of the film.

In a preferred embodiment, the polypropylene-based plastomer/elastomer sealant layer 50 is from 15 to 20 weight percent of the film and from 0 to 20% secondary LDPE component, based on the total weight of the film.

A multi-layer polymeric film 10, as shown in FIG. 3, has an elongation at break measured in accordance with ASTM D 882 of greater than 400%, Spencer impact of more than 800 mJ; a puncture strength of greater than 7 lbs; a seal initiation temperature less than or equal to 120° C.; a seal strength measured in accordance with ASTM F88-07a in the range of 100 gf/in to 2000 gf/in; and a delamination strength of greater than 1500 gf/in wherein the elongation at break is measured in accordance with ASTM D 882; puncture is measured in accordance with ASTM D7192; Spencer impact is measured in accordance with ASTM D 3420; and ultimate seal strength is measured in accordance with ASTM F88-07a.

The film is thermoformable and entirely recyclable

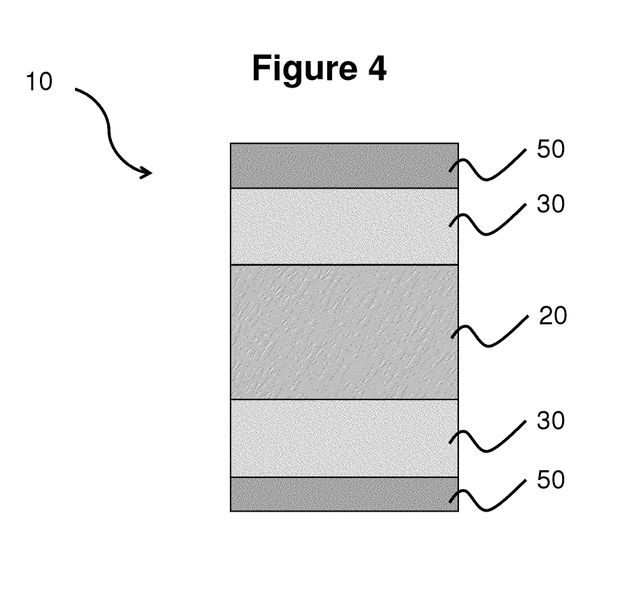

FIG. 4 shows an embodiment of the multi-layer polymeric film 10 of the present invention having a first polypropylene-based plastomer/elastomer sealant layer 50; a second structural layer of homogenous polypropylene 20; a third structural layer of random copolymer polypropylene 30; a fourth structural layer of homogenous polypropylene 20; and a fifth polypropylene-based plastomer/elastomer sealant layer 50.

The first polypropylene-based plastomer/elastomer sealant layer 50 is from 10 to 30 weight percent of the film and up to 50% secondary LDPE component, based on the total weight of the film. In a preferred embodiment, the first polypropylene-based plastomer/elastomer sealant layer 50 is from 15 to 20 weight percent of the film and from 0 to 20% secondary LDPE component, based on the total weight of the film.

The second structural layer of homogenous polypropylene 20 is from 5 to 15 weight percent of the film, based on the total weight of the film. In a preferred embodiment, the second structural layer of homogenous polypropylene 20 is 10 weight percent of the film, based on the total weight of the film.

The third structural layer of random copolymer polypropylene 30 is from 30 to 50 weight percent of the film, based on the total weight of the film. In a preferred embodiment, the third structural layer of random copolymer polypropylene 30 is from 35 to 45 weight percent of the film, based on the total weight of the film.

The fourth structural layer of homogenous polypropylene 20 is from 5 to 15 weight percent of the film, based on the total weight of the film. In a preferred embodiment, the fourth structural layer of homogenous polypropylene 20 is 10 weight percent of the film, based on the total weight of the film.

The a fifth polypropylene-based plastomer/elastomer sealant layer 50 is from 10 to 35 weight percent of the film and up to 50% secondary LDPE component, based on the total weight of the film. In a preferred embodiment, the fifth polypropylene-based plastomer/elastomer sealant layer 50 is from 15 to 20 weight percent of the film and from 0 to 20% secondary LDPE component, based on the total weight of the film.

A multi-layer polymeric film 10, as shown in FIG. 4, has an elongation at break measured in accordance with ASTM D 882 of greater than 400%, Spencer impact of more than 800 mJ; a puncture strength of greater than 7 lbs; a seal initiation temperature less than or equal to 120° C.; a seal strength measured in accordance with ASTM F88-07a in the range of 100 gf/in to 2000 gf/in; and a delamination strength of greater than 1500 gf/in wherein the elongation at break is measured in accordance with ASTM D 882; puncture is measured in accordance with ASTM D7192; Spencer impact is measured in accordance with ASTM D 3420; and ultimate seal strength is measured in accordance with ASTM F88-07a.

The film is thermoformable and entirely recyclable

In one or more embodiments of the present invention, applications of the polymeric film described herein include, but not limited to, use in blister packaging; vertical or horizontal form fill seal packaging; pouches and bags; and flow wrap packaging.

In one or more embodiments of the present invention, multi-layer polymeric films having one or more linear low density polyethylene (LLDPE) blend sealant layers have a seal window greater than 30° C.

The film of the present invention has a gauge in the range from 1 mil to 80 mil.

### Manufacturing

The multi-layer film structure of the present invention may be fabricated using known conventional blown, cast, extruded or laminate film techniques. The LLDPE sealant blends, and all other blends and potentially all other additives described previously, could be melt blended, compounded in or dry blended, relying on the extruder of the film fabrication line extruded to blend the two components, eliminating the additional cost of a secondary compounding step.

### Description of Test Methods

Haze and Luminous transmittance of transparent plastics is measured in accordance with ASTM D-1003-07 and is reported as percent haze, to the nearest 0.1%. As defined in ASTM D-1003-07, haze is the scattering of light by a specimen responsible for the reduction in contrast of objects viewed through it.

Impact resistance is defined as the determination of the energy that causes plastic film to fail under specified conditions of impact of a free-falling dart and is measured in accordance with ASTM D1709-08. Impact resistance is reported as impact failure weight, to the nearest 1 g.

Hot seal strength (hot tack) is defined as measurement of the strength of heat seals formed between thermoplastic surfaces of flexible webs, immediately after a seal has been made and before it cools to ambient temperature. Hot seal strength (hot tack) is measured in accordance with ASTM F-1921 and is reported as units of gf/in.

Seal strength, also referred to as peel strength, is defined as force per unit width of seal required to separate progressively a flexible material from a rigid material or another flexible material and is measured in accordance with ASTM F88-07a and is reported as units of gf/in. Seal strength for the film of the present invention is in the range from 200 Win min to 2500 g/in max. Seal Strength measurements are conducted using a standard bar sealer when heat sealed to self, top seal bar at 280 F, 1.0 s Dwell, 50 psi. Heated bottom bar @ 100 F, Gasket type (Silicone Rubber, 60 Shore A, ⅛″ thick, Medium (Diamond, 0.012″ resolution)), sealing sample prepared 24 hrs prior to peeling test.

Densities are measured in accordance with ASTM D-792 and are reported as grams/cubic centimeter (g/cc).

Melt index measurements are performed according to ASTM D-1238. Melt index is inversely proportional to the molecular weight of the polymer. Thus, the higher the molecular weight, the lower the melt index, although the relationship is not linear. Melt index is reported as g/10 minutes. Melt index determinations can also be performed with even higher weights, such as in accordance with ASTM D-1238. ASTM D-1238 is also used to determine the melt flow rate (MFR) of a thermoplastic material. The units of measure are grams of material/10 minutes (g/10 min). It is based on the measurement of the mass of material that extrudes from the die over a given period of time.

Spencer impact strength measured in accordance with ASTM D 3420 for the determination of resistance of film to impact-puncture penetration. The average impact strength is measured in joules or centimeters kilograms-force.

Slow rate puncture measured in accordance with ASTM D7192 for the determination of the resistance of the film to puncture. The average puncture strength is measured in pounds-force.

Tensile properties for the film are measured in accordance with ASTM D882. The elongation at break is a measure of the amount of deformation the film is capable of prior to break. Elongation to break is measured in % change of initial gauge length.

Heat seal initiation temperature is defined as the minimum temperature at which a 50 gf/in seal strength is achieved.

Hot tack initiation temperature is defined as the minimum seal temperature required to develop a 20 gf/in seal strength.

Delamination strength is defined as the seal strength value by which the sealed film pairs fail by separation of the layers of one of the films not at the point of seal between the two films.

### COMPARATIVE EXAMPLE

The following five exemplary blown films of the present invention were produced using a Brampton® 8 layer line extruder having between 2-2½″ diameter and 30:1 L/D. Conventional metering screws w/ Maddock® mixing head were utilized. The die diameter was 18″ and a gravimetric feeder was used during the fabrication process. A Brampton® dual lip air ring (external air cooling) and Internal Bubble Cooling were used. The blow up ratio was 1.48:1.

The compositions of the five films of the present invention were as follows:

Film A—is an embodiment of the multi-layer polymeric film of the present invention, as shown in FIG. 2, having a linear low density polyethylene (LLDPE) blend sealant layer having a primary Metallocene LLDPE component blended with 20% LDPE additive component having 1% slip agent, 3% anti-block agent; a second structural layer of random copolymer polypropylene; a third structural layer of homogenous polypropylene; a fourth structural layer of random copolymer polypropylene; and a linear low density polyethylene (LLDPE) blend sealant layer having a primary Ziegler-Natta LLDPE component with 20% LDPE additive component having 4% slip agent, 5% anti-block agent.

Film B—is an embodiment of the multi-layer polymeric film of the present invention, as shown in FIG. 3, having a polypropylene-based sealant top layer without LDPE additive having 4% slip agent, 2% processing aid and 2% anti-block agent; a second structural layer of random copolymer polypropylene; a third structural layer of homogenous polypropylene; a fourth structural layer of random copolymer polypropylene; a polypropylene-based sealant layer without LDPE additive and having 4% slip agent, 2% processing aid and 2% anti-block agent.

Film C—is an embodiment of the multi-layer polymeric film of the present invention, as shown in FIG. 3, having a polypropylene-based sealant top layer with 20% LDPE additive component, 3% slip agent and 2% anti-block agent; a second structural layer of random copolymer polypropylene; a third structural layer of homogenous polypropylene; a fourth structural layer of random copolymer polypropylene; a polypropylene-based sealant layer with 20% LDPE additive component, 3% slip agent and 2% anti-block agent.

Film D—an embodiment of the multi-layer polymeric film of the present invention, as shown in FIG. 4, having a first polypropylene-based plastomer/elastomer sealant layer without LDPE additive, and with 4% slip agent, 2% processing aid, and 2% anti-block agent; a second structural layer of homogenous polypropylene; a third structural layer of random copolymer polypropylene; a fourth structural layer of homogenous polypropylene; and a fifth polypropylene-based plastomer/elastomer sealant layer without LDPE additive, and with 4% slip agent, 2% processing aid, and 2% anti-block agent.

Film E—an embodiment of the multi-layer polymeric film of the present invention, as shown in FIG. 4, having a first polypropylene-based plastomer/elastomer sealant layer with 20% LDPE additive, 4% slip agent, 2% processing aid and 2% anti-block agent; a second structural layer of homogenous polypropylene; a third structural layer of random copolymer polypropylene; a fourth structural layer of homogenous polypropylene; and a fifth polypropylene-based plastomer/elastomer sealant layer with 20% LDPE additive, 4% slip agent, 2% processing aid and 2% anti-block agent.

The five exemplary blown films of the present invention were compared and tested to a commercially available 7-layer blown film with a nylon structural component and an EVA-based sealant, having an anhydride-based resin for the tie layer. It is noted that all of the films were fabricated using a blown film process and are 5 mil.

For the following tests, the elongation at break is measured in accordance with ASTM D 882; puncture is measured in accordance with ASTM D7192; Spencer impact is measured in accordance with ASTM D 3420; and ultimate seal strength is measured in accordance with ASTM F88-07a. The following values were obtained as shown in Table 1:

TABLE 1

| Tests | Unit | (Control) | Film A | Film B | Film C | Film D | Film E |
|---|---|---|---|---|---|---|---|
| Tensile Elongation Break (MD) | % | 398 | 657 | 587 | 550 | 570 | 599 |
| Tensile Elongation Break (TD) | % | 428 | 651 | 680 | 727 | 731 | 706 |
| Impact | mJ | 2044 | 1650 | 1777 | 926 | 1928 | 1760 |
| Puncture | lbs | 8.1 | 8.6 | 8.6 | 9.2 | 8.4 | 8.5 |
| Seal Initiation Temperature | C. | 110 | 90 | 110 | 110 | 110 | 107 |
| Seal Window | deg | 30 | 40 | NA | NA | NA | NA |
| Delamination Strength | gf/in | 1320 | 2665 | 6266 | 2255 | 2177 | 2095 |

As noted above in Table 1, the control film with a tie layer delaminates (i.e. the film layers separate) at 1320 gf/in. As shown above, the lowest delamination force for tested embodiments of the present invention was 2095 gf/in for Film E. Thus, the films of the present invention demonstrate an inter-layer adhesion which exceeds the delamination strength of a conventional film w/ tie layers.

Seal window is determined from the temperature interval at which a measurable seal occurs to the temperature at which delamination occurred.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A multi-layer polymeric film comprising:
one or more structural layers of homogenous polypropylene and having a melt flow rate from 0.5 to 10 MFR;
one or more structural layers of random copolymer polypropylene having a melt flow rate from 0.5 to 10 MFR;
one or more polypropylene-based plastomer/elastomer sealant layers having a melt flow rate from 0.5 to 10 MFR;
wherein the multi-layer polymeric film has an elongation at break of greater than 400%, puncture strength greater than 7 lbs; Spencer impact of more than 800 mJ; a delamination strength of greater than 1500 gf/in; seal initiation temperature less than or equal to 120° C.; a seal strength in the range of 100-2000 gf/in,
wherein the elongation at break is measured in accordance with ASTM D 882; puncture strength is measured in accordance with ASTM D 7192; Spencer impact is measured in accordance with ASTM D 3420; and ultimate seal strength is measured in accordance with ASTM F88-07a.

2. The multi-layer polymeric film composition of claim 1 wherein one or more structural layers of homogenous polypropylene is from 20 to 60 weight percent of the film, based on the total weight of the film.

3. The multi-layer polymeric film composition of claim 1 wherein the one or more structural layers of random copolymer polypropylene is from 30 to 70 weight percent of the film, based on the total weight of the film.

4. The multi-layer polymeric film composition of claim 1 wherein the sealant layer is from 10 to 40 weight percent of the film, based on the total weight of the film.

5. The multi-layer polymeric film composition of claim 1 wherein the sealant layer has a density in the range from 0.850 to 0.905 g/cm³.

6. The multi-layer polymeric film composition of claim 1 wherein the high ethylene content random copolymer polypropylene has greater than or equal to 3% ethylene weight percentage.

7. A multi-layer polymeric film of claim 1 wherein the multi-layer polymeric film is entirely recyclable.

8. A multi-layer polymeric film comprising:
a linear low density polyethylene (LLDPE) blend sealant layer having a primary Metallocene LLDPE component with a a second structural layer of random copolymer polypropylene having a melt flow rate from 0.5 to 10 MFR;
a third structural layer of homogenous polypropylene having a melt flow rate from 0.5 to 10 MFR;
a fourth structural layer of random copolymer polypropylene having a melt flow rate from 0.5 to 10 MFR;
and a linear low density polyethylene (LLDPE) blend sealant layer having a primary Ziegler-Natta LLDPE component with;
wherein the multi-layer polymeric film has an elongation at break measured in accordance with ASTM D 882 of greater than 400%; puncture strength greater than 7 lbs measured in accordance with ASTM D 7192; Spencer impact strength measured in accordance with ASTM D 3420 of more than 800 mJ; a delamination strength of greater than 1500 gf/in; a seal initiation temperature less than or equal to 120° C.; a seal strength measured in accordance with ASTM F88-07a in the range of 100 gf/in to 2000 gf/in; and a seal window greater than 30° C.

9. The multi-layer polymeric film of claim 8 wherein the LLDPE sealant layers comprises an LDPE additive component.

10. The multi-layer polymeric film composition of claim 8 wherein the linear low density polyethylene (LLDPE) blend sealant layer having a primary Metallocene LLDPE component is from 10 to 30 weight percent of the film and up to 40% secondary LDPE component, based on the total weight of the film.

11. The multi-layer polymeric film composition of claim 8 wherein the second structural layer is from 10 to 30 weight percent of the film, based on the total weight of the film.

12. The multi-layer polymeric film composition of claim 8 wherein the third structural layer of homogenous polypropylene is from 5 to 30 weight percent of the film, based on the total weight of the film.

13. The multi-layer polymeric film composition of claim 8 wherein the fourth structural layer is from 10 to 30 weight percent of the film, based on the total weight of the film.

14. The multi-layer polymeric film composition of claim 8 wherein the linear low density polyethylene (LLDPE) blend sealant layer having a primary Ziegler-Natta LLDPE component is from 10 to 35 weight percent of the film and up to 50% secondary LDPE component, based on the total weight of the film.

15. A multi-layer polymeric film of claim 8 wherein the multi-layer polymeric film is entirely recyclable.

16. A multi-layer polymeric film of claim 8 wherein the multi-layer polymeric film is thermoformable.

17. A multi-layer polymeric film comprising:
a first polypropylene-based plastomer/elastomer sealant layer,
a second structural layer of random copolymer polypropylene having a melt flow rate from 0.5 to 10 MFR;
a third structural layer of homogenous polypropylene having a melt flow rate from 0.5 to 10 MFR;
a fourth structural layer of random copolymer polypropylene having a melt flow rate from 0.5 to 10 MFR;
a fifth polypropylene-based plastomer/elastomer sealant layer;
wherein the multi-layer polymeric film has an elongation at break of greater than 400%, puncture strength greater than 7 lbs; Spencer impact of more than 800 mJ; a delamination strength of greater than 1500 gf/in; seal initiation temperature less than or equal to 120° C.; a seal strength in the range of 100-2000 gf/in,
wherein the elongation at break is measured in accordance with ASTM D 882; puncture strength is measured in accordance with ASTM D 7192; Spencer impact is measured in accordance with ASTM D 3420; and ultimate seal strength is measured in accordance with ASTM F88-07a.

18. The multi-layer polymeric film composition of claim 17 wherein the first polypropylene-based plastomer/elastomer sealant layer is from 10 to 30 weight percent of the film and up to 50% secondary LDPE component, based on the total weight of the film.

19. The multi-layer polymeric film composition of claim 17 wherein the second structural layer is from 10 to 30 weight percent of the film, based on the total weight of the film.

20. The multi-layer polymeric film composition of claim 17 wherein the third structural layer of homogenous polypropylene is from 5 to 30 weight percent of the film, based on the total weight of the film.

21. The multi-layer polymeric film composition of claim 17 wherein the fourth structural layer is from 10 to 30 weight percent of the film, based on the total weight of the film.

22. The multi-layer polymeric film composition of claim 17 wherein the a fifth polypropylene-based plastomer/elastomer sealant layer is from 10 to 35 weight percent of the film and up to 50% secondary LDPE component, based on the total weight of the film.

23. A multi-layer polymeric film of claim 17 wherein the multi-layer polymeric film is entirely recyclable.

24. A multi-layer polymeric film of claim 17 wherein the multi-layer polymeric film is thermoformable.

25. A multi-layer polymeric film comprising:
a first polypropylene-based plastomer/elastomer sealant layer,
a second structural layer of homogenous polypropylene having a melt flow rate from 0.5 to 10 MFR;
a third structural layer of random copolymer polypropylene having a melt flow rate from 0.5 to 10 MFR;
a fourth structural layer of homogenous polypropylene having a melt flow rate from 0.5 to 10 MFR;
a fifth polypropylene-based plastomer/elastomer sealant layer;
wherein the multi-layer polymeric film has an elongation at break of greater than 400%, puncture strength greater than 7 lbs; Spencer impact of more than 800 mJ; a delamination strength of greater than 1500 gf/in; seal initiation temperature less than or equal to 120° C.; a seal strength in the range of 100-2000 gf/in,
wherein the elongation at break is measured in accordance with ASTM D 882; puncture strength is measured in accordance with ASTM D 7192; Spencer impact is measured in accordance with ASTM D 3420; and ultimate seal strength is measured in accordance with ASTM F88-07a.

26. The multi-layer polymeric film composition of claim 25 wherein the first polypropylene-based plastomer/elastomer sealant layer is from 10 to 30 weight percent of the film and up to 50% secondary LDPE component, based on the total weight of the film.

27. The multi-layer polymeric film composition of claim 25 wherein the second structural layer of homogenous polypropylene is from 5 to 15 weight percent of the film, based on the total weight of the film.

28. The multi-layer polymeric film composition of claim 25 wherein the third structural layer of random copolymer polypropylene is from 30 to 50 weight percent of the film, based on the total weight of the film.

29. The multi-layer polymeric film composition of claim 25 wherein the fourth structural layer of homogenous polypropylene is from 5 to 15 weight percent of the film, based on the total weight of the film.

30. The multi-layer polymeric film composition of claim 25 wherein the a fifth polypropylene-based plastomer/elastomer sealant layer is from 10 to 35 weight percent of the film and up to 50% secondary LDPE component, based on the total weight of the film.

31. A multi-layer polymeric film of claim 25 wherein the multi-layer polymeric film is entirely recyclable.

32. A multi-layer polymeric film of claim 25 wherein the multi-layer polymeric film is thermoformable.
